(19) United States
(12) Patent Application Publication
(10) Pub. No.: US 2024/0247929 A1
(43) Pub. Date: Jul. 25, 2024

(54) Electronic Device with Optical Angle Sensor

(71) Applicant: Apple Inc., Cupertino, CA (US)

(72) Inventors: Ruonan Yang, Santa Clara, CA (US); David D. Dashevsky, San Jose, CA (US); Dong Zheng, Los Altos, CA (US)

(21) Appl. No.: 18/505,965

(22) Filed: Nov. 9, 2023

Related U.S. Application Data
(60) Provisional application No. 63/480,880, filed on Jan. 20, 2023.

(51) Int. Cl. G01B 11/26; G06F 1/16

(52) U.S. Cl. CPC G01B 11/26; G06F 1/1681

(57) ABSTRACT

An electronic device can include housing with first and second housing portions configured to rotate relative to one another about a hinge, a hinge angle encoder that rotates with the hinge, an emitter that emits light towards the hinge angle encoder, and a sensor die that receives light reflecting back from the hinge angle encoder. The hinge angle encoder may include an absorptive polarizing filter layer and a reflective diffuser layer. A pixelated polarizer may be formed overlapping an array of photodetectors in the sensor die. The electronic device may include processing circuitry configured to compute a hinge angle by which the first and second housing portions are rotated based on one or more intensity values acquired using the array of photodetectors.

This application claims the benefit of U.S. Provisional Patent Application No. 63/480,880, filed Jan. 20, 2023, which is hereby incorporated by reference herein in its entirety.

### FIELD

This relates generally to electronic devices, and, more particularly, to electronic devices with hinges.

### BACKGROUND

An electronic device can sometimes fold about a hinge. Such foldable electronic device can include a first housing portion and a second housing portion that folds with respect to the first housing portion about the hinge. The electronic device can sometimes include an angle sensor for detecting whether the first and second housing portions are in a folded position or an unfolded position.

It can be challenging to design an angle sensor for foldable electronic devices. Conventional angle sensors are typically implemented using magnetic angle sensors. Magnetic angle sensors, however, are susceptible to magnetic fields from static magnets, which can be found in many electronic devices. It is within this context that the embodiments herein arise.

### SUMMARY

An electronic device may be provided with first and second housing portions that can rotate relative to each other about a hinge. In accordance with an aspect of the disclosure, the electronic device can further include a hinge angle encoding structure disposed on the hinge, an emitter configured to emit light towards the hinge angle encoding structure, a sensor die configured to receive the light reflecting back from the hinge angle encoding structure, and a polarizing filter layer disposed on the sensor die. The hinge angle encoding structure can include an additional polarizing filter layer and a reflective diffuser layer interposed between the additional polarizing filter layer and the hinge. The additional polarizing filter layer can be a linear polarizer or an absorptive polarizer. The hinge angle encoding structure can be a reflective polarizer. The hinge angle encoding structure can include an additional polarizing filter layer and a specular reflector layer interposed between the additional polarizing filter layer and the hinge. The polarizing filter layer can be a pixelated polarizer. The emitter can optionally be stacked on the sensor die. The emitter and sensor die can be housed within a sensor assembly cap having a midwall separating the sensor die and the emitter.

An aspect of the disclosure provides a method of operating an optical hinge angle sensor in the electronic device. The method can include using an emitter to emit light towards a hinge angle encoding structure on the hinge, using a polarizing filter layer to polarize the light reflecting back from the hinge angle encoding structure, using a sensor die to sense polarized light traversing the polarizing filter layer and outputting one or more intensity values, and computing an angle at which the plurality of housing portions are rotated about the hinge based on the one or more intensity values. Computing the angle can involve converting the intensity values to corresponding sine and cosine bases, performing gain and offset correction on the sine and cosine bases, filtering the sine and cosine bases, and/or computing an arctangent function using the sine and cosine bases.

An aspect of the disclosure provides an electronic device that includes housing comprising first and second housing portions that rotate relative to each other about a hinge, a hinge angle encoding structure disposed on the hinge, and a sensor die facing the hinge angle encoding structure. The sensor die can include first and second photodetectors formed in a substrate, interconnect routing layers formed on the substrate, multiple layers of parallel polarizing metal lines in the interconnect routing layers routed in a first direction and overlapping the first photodetectors, and multiple layers of parallel polarizing metal lines in the interconnect routing layers routed in a second direction orthogonal to the first direction and overlapping the second photodetectors. The electronic device can include control circuitry configured to sample first signals output from the first photodetectors, to sample second signals output from the second photodetectors, to compute a difference of the first and second signals, and to compute a hinge angle at which the plurality of housing portions are rotated about the hinge based on the computed difference.

### BRIEF DESCRIPTION OF THE DRAWINGS

FIG. 1 is a schematic diagram of an illustrative electronic device in accordance with some embodiments.

FIG. 2 is a perspective view of an illustrative foldable electronic device with a hinge in accordance with some embodiments.

FIG. 3 is a top view of an illustrative hinge assembly and an associated optical hinge angle sensor assembly in accordance with some embodiments.

FIG. 4 is a perspective view of a sensor lid having a mid-wall in accordance with some embodiments.

FIG. 5 is a top view of an optical hinge angle sensor with overmold in accordance with some embodiments.

FIGS. 6A-6D are top views of various pixelated polarizer filters having polarizer pixels offset by 45 degree increments in accordance with some embodiments.

FIGS. 7A-7C are top views of various pixelated polarizer filters having polarizer pixels offset by 60 degree increments in accordance with some embodiments.

FIG. 8 is a flow chart of illustrative steps for operating an optical hinge angle sensor in accordance with some embodiments.

FIG. 9A is diagram of an illustrative polarizer disc, formed as part of a hinge assembly, in a folded position in accordance with some embodiments.

FIG. 9B is a diagram of the polarizer disc of FIG. 9A in a partially unfolded (rotated) position in accordance with some embodiments.

FIG. 10 a perspective view of an integrated circuit having orthogonal interconnect metal layer wire grid polarizers in accordance with some embodiments.

FIG. 11 is a diagram of interleaving orthogonal polarization photodetectors and associated processing circuits configured to compute a hinge angle in accordance with some embodiments.

FIG. 12 is a top view of an illustrative hinge assembly that can be used to provide 360 degree angle sensing range in accordance with some embodiments.

FIG. 13 is a diagram of an illustrative disc layer in the hinge assembly of FIG. 12 having a first semicircle all-pass portion and having a second semicircle band-pass portion in accordance with some embodiments.

FIG. 14 is a top view of an illustrative hinge assembly and an associated optical hinge angle sensor assembly with a polarizing filter over an emitter in accordance with some embodiments.

FIG. 15 is a top view of an illustrative hinge assembly and an associated optical hinge angle sensor having an emitter covered by a polarizing filter and having a sensor covered by a pixelated polarizing filter attached to the hinge assembly in accordance with some embodiments.

### DETAILED DESCRIPTION

An electronic device may be provided with a hinge that allows a first housing portion to rotate with respect to a second housing portion. Such electronic device may be operated in a closed (folded) position where the angle between the first and second housing portions is equal to zero, in an open (unfolded) position where the angle between the first and second housing portions is equal to a maximum value, or in a partially open position where the angle between the first and second housing portions is equal to some intermediate value between zero and the maximum value. The angle between the first and second housing portions is sometimes referred to as the hinge angle. In accordance with some embodiments, an electronic device can be provided with an angle sensor configured to detect or compute the hinge angle.

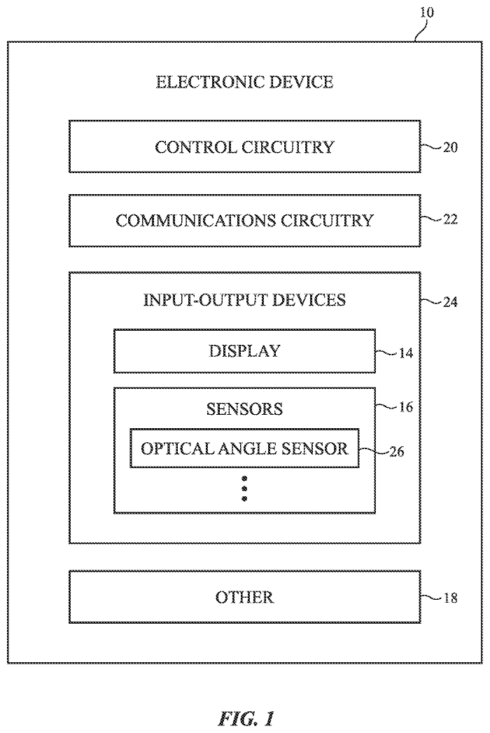

A schematic diagram of an illustrative electronic device such as electronic device 10 having an angle sensor is shown in FIG. 1. Device 10 may be a cellular telephone, tablet computer, laptop computer, wristwatch device or other wearable device, a head-mounted device, a television, a stand-alone computer display or other monitor, a computer display with an embedded computer (e.g., a desktop computer), a system embedded in a vehicle, kiosk, or other embedded electronic device, a media player, or other electronic equipment. Device 10 may be a foldable or bendable electronic device having one or more hinge(s). For example, device 10 may be a laptop computer having a first housing portion with a display and a second housing portion with a keyboard that rotate relative to each other about a hinge. Configurations in which device 10 is a laptop computer, cellular telephone, tablet computer, or other portable electronic device may sometimes be described herein as an example. This is illustrative. Device 10 may, in general, be any type of electronic device.

Device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use a display and other output devices in providing a user with visual output and other output.

To support communications between device 10 and external equipment, control circuitry 20 may communicate using communications circuitry 22. Circuitry 22 may include antennas, radio-frequency transceiver circuitry (wireless transceiver circuitry), and other wireless communications circuitry and/or wired communications circuitry. Circuitry 22, which may sometimes be referred to as control circuitry and/or control and communications circuitry, may support bidirectional wireless communications between device 10 and external equipment over a wireless link (e.g., circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link). Wireless communications may, for example, be supported over a Bluetooth® link, a WiFi® link, a wireless link operating at a frequency between 6 GHz and 300 GHz, a 60 GHz link, or other millimeter wave link, cellular telephone link, wireless local area network link, personal area network communications link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display 14. Display 14 may be an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), and/or other display. Display 14 may have an array of pixels configured to display images for a user.

Sensors 16 in input-output devices 24 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping display 14, and/or a touch sensor that forms a button, trackpad, or other input device not associated with a display), and other sensors.

If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, and/or other sensors. In accordance with some embodiments, sensors 16 can include an optical sensor 26 configured to measure a hinge angle between two housing portions that rotate relative to each other about a hinge. Such type of sensor that uses light to measure the hinge angle is sometimes referred to as an optical angle sensor or an optical hinge angle sensor 26.

In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

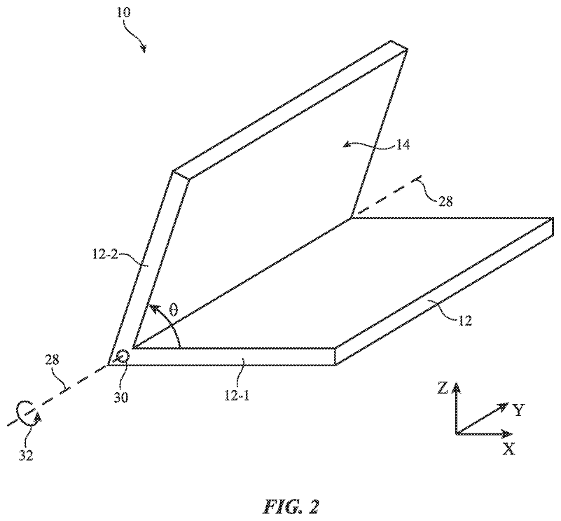

FIG. 2 is a perspective view of electronic device 10 having a hinge 30. Hinge 30 (sometimes referred to herein as hinge structures, a hinge assembly, or a clutch barrel) can be configured to allow a first housing portion 12-1 to rotate in directions 32 about a rotational axis 28 relative to a second housing portion 12-2 of device 10 with a certain amount of friction. Rotational axis 28 is sometimes referred to as a hinge axis. Hinge 30 may have a first part rigidly attached to the first housing portion 12-1 and may have a second part rigidly attached to the second housing portion 12-2. Display 14 can be mounted in the second housing portion 12-2 of device 10. Display 14 may cover some or all of the front face of second housing portion 12-2. Display 14 may be protected using a display cover layer such as a layer of transparent glass or clear plastic. Touch sensor circuitry such as two-dimensional capacitive touch sensor circuitry may be incorporated into display 14. Second housing portion 12-2, which may sometimes be referred to as a display housing or lid, can be placed in a closed position by rotating housing 12-2 towards first housing portion 12-1 about rotational axis 28. Hinge 30 may extend along the entire length of lid 12-2 or may be included in only a portion of lid 12-2.

A keyboard, touchpad, speakers, and/or other input-output devices may be mounted in the first housing portion 12-1 of device 10. First housing portion 12-1 is sometimes referred to as a base housing or keyboard housing of device 10. First housing portion 12-1 and second housing portion 12-2 can be referred to collectively as device housing 12. Housing 12 may form front and rear housing walls, sidewall structures, and/or internal supporting structures (e.g., a frame, an optional midplate member, etc.) for device 10. Housing 12 may be formed from plastic, glass, ceramics, fiber composites, metal (e.g., stainless steel, aluminum, etc.), other suitable materials, or a combination of any two or more of these materials.

The angle of rotation between the two housing portions 12-1 and 12-2 as they are rotated about axis 28 can be defined as a hinge angle or lid angle θ. When device 10 is not in use, lid housing portion 12-2 may be closed and angle θ may be equal to 0° (e.g., base housing 12-1 and lid housing 12-2 may be parallel). When device 10 is in use, lid housing portion 12-2 may be separated from base housing 12-1 by a non-zero angle θ. During use, hinge angle θ can have a value between 90° and 135°, although other angles may be used if desired. The example of FIG. 2 in which electronic device 10 has a hinge 30 connecting two different housing portions 12-1 and 12-2 is merely illustrative. In other embodiments, device 10 may have two hinges linking together three different housings, three hinges linking together four different housings, four hinges linking together five different housings, four to ten hinges, or more than 10 hinges linking together any suitable number of housing portions.

An electronic device such as a laptop computer can sometimes be provided with a lid angle sensor configured to detect the lid angle. Existing lid angle sensors are implemented using magnetic angle sensors that employ single dipole diametrically magnetized permanent magnets attached to the hinge. Such type of magnetic angle sensors tends to be too large to be placed on-axis (i.e., magnetic sensors are too large to fit in a position along the hinge axis 28). If care is not taken, the accuracy of magnetic angle sensors can also be degraded by external magnetic fields from other electronic devices that might include static or permanent magnets.

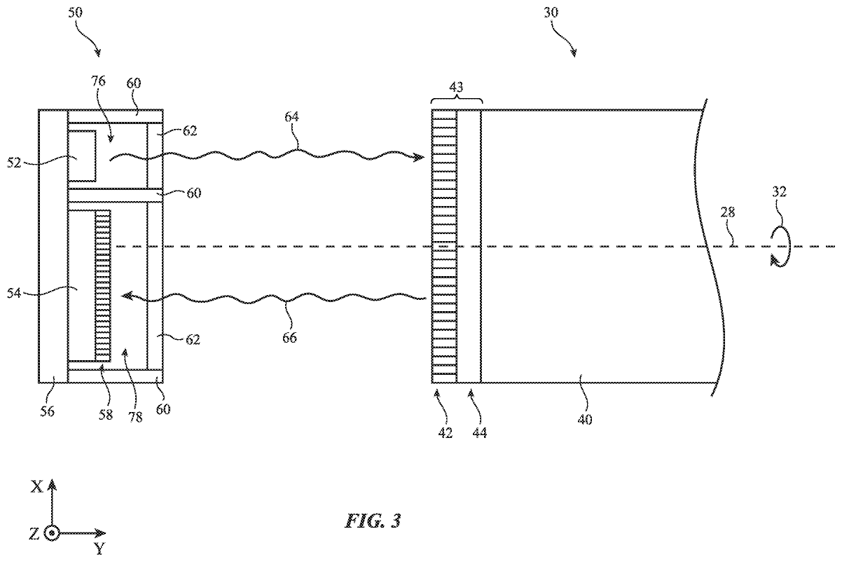

In accordance with an embodiment, device 10 can be provided with an optical (e.g., light based) angle sensor for detecting, measuring, or computing the hinge angle. FIG. 3 is a top view of an illustrative hinge assembly such as hinge assembly 30 and an associated optical hinge angle sensor assembly 50. Use of an optical angle sensor may be technically advantageous over a magnetic angle sensor since optical angle sensors are substantially less susceptible to interference from external magnetic fields. As shown in FIG. 3, hinge assembly 30 may include an elongated hinge structure 40 that extends along rotational axis 28. Hinge structure 40 may have a first part rigidly attached to the first housing 12-1 and a second part rigidly attached to the second housing 12-2 (see, e.g., FIG. 2) and may be configured to allow the two housing portions to rotate with respect to one another along the hinge axis with a certain amount of friction.

A reflective polarization angle encoder disc such as reflective polarization angle encoder disc 43 may be disposed at a distal end of hinge structure 40. Angle encoder disc 43 is sometimes referred to herein as a hinge angle encoding structure. Encoder disc 43 can include a polarization layer such as polarizing filter layer 42 and a reflective layer such as reflective layer 44. Polarization filter layer 42 may be an absorptive polarizer (e.g., a polarizer that absorbs light that is orthogonal to the polarization direction of that polarizer as opposed to a reflective polarizer that reflects light not aligned with its polarization direction). Layer 42 is therefore sometimes referred to as an absorptive polarization filter layer. Polarization filter layer 42 may also be a reflective polarizer such as a wire grid polarizer or diffuse reflective polarizer. Accordingly, layer 44 can be an absorptive layer that absorbs any light passing through layer 42.

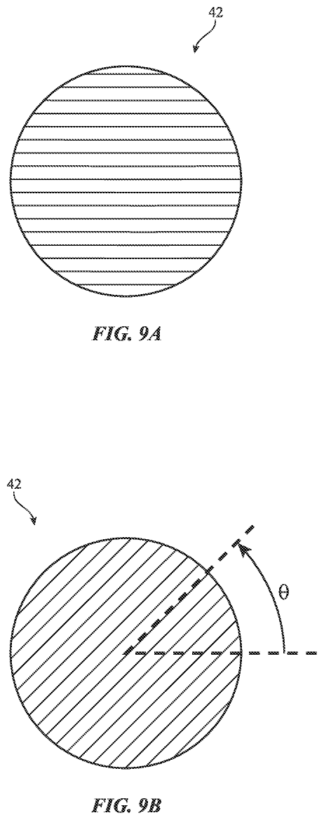

FIG. 9A is a side view of linear polarizer 42. Unpolarized light entering linear polarizer 42 may emerge from the linear polarizer 42 as linearly polarized light that vibrates in the plane or direction parallel to the lines (wires) shown in FIG. 9A. FIG. 9A might correspond to the position of polarizer 42 when the hinge (rotational) angle is equal to 0° (e.g., when the two housing portions of device 10 are folded in a closed position). FIG. 9B shows a side view of linear polarizer 42 when the hinge is rotated by an angle θ. Unpolarized light entering linear polarizer 42 may exit the linear polarizer 42 as linearly polarized light vibrating in the plane or direction parallel to the lines or wires shown in FIG. 9B. Thus, the rotational angle θ of the hinge can be encoded in terms of the polarization direction of the light egressing from linear polarizer 42. This example in which encoder disc 43 has a circular cross section is merely illustrative. In general, hinge 30 and the associated encoder disc 43 can have a cross-sectional shape that is non-circular, rectangular, square, oval, a shape with one or more curved edges, a shape with one or more straight edges, or other suitable shape. Angle encoder disc 43 is therefore sometimes referred to more generically as a hinge angle encoding structure.

Referring back to FIG. 3, the reflective layer 44 of angle encoder disc 43 may be interposed between hinge structure 40 and polarization filter layer 42. In one embodiment, reflective layer 44 may be a reflective diffuser layer. For example, reflective diffuser 44 may have a surface coated with white paint or other non-light-absorptive coating, may be formed from opaque or semi-opaque white polymer material, may be formed from white paper, may be formed from white fabric material, may be formed from white ceramic material, or may be formed from other reflective material with a rough, irregular, or light scattering (diffusive) surface. Implementing layer 44 as a reflective diffuser may be beneficial or technically advantageous since a diffusive layer helps with particle alignment and insensitivity by averaging or spreading light across the entire surface of disc layer 44, which can help reduce error.

In another embodiment, reflective layer 44 may be a specular reflector formed from plane mirror, metal (e.g., gold, silver, aluminum, copper, steel, etc.), or other reflective layer with a highly polished, specular (non-diffusive), glossy, shiny, or smooth surface. The example of FIG. 3 in which angle encoder disc 43 includes two separate polarization and reflective layers is merely illustrative. In yet another embodiment, angle encoder disc 43 might be implemented as one integrated reflective polarizer (e.g., a reflective wire grid polarizer). A reflective wire grid polarizer may have a surface that provides specular reflection without diffusive reflection. If desired, a reflective wire grid polarizer can alternatively have a surface that provides diffuse reflection. In general, angle encoder disc 43 may include one or more layers of different materials, two or more layers or different materials, three or more layers of different materials, or four or more layers of different materials. Sensor configurations in which angle encoder disc 43 includes a linear polarizer layer 42 and a reflective diffuser layer 44 are sometimes described herein as an example. Hinge structure 40 and angle encoder disc 43 may collectively be referred to or defined herein as a hinge assembly, hinge structures, or hinge.

Still referring to FIG. 3, optical angle sensor assembly 50 can include a substrate layer such as substrate 56, an emitting device such as emitter 52 that is mounted on substrate 56, and a sensor die such as sensor die 54 that is mounted on substrate 56. Emitter 52 and sensor die 54 may be covered by a sensor assembly lid or cap having sidewalls 60. Optical angle sensor assembly 50 and the opposing angle encoder disc 43 on the hinge can sometimes be referred to collectively as the optical hinge angle sensor (i.e., encoder disc 43 can be considered as being part of the optical angle sensor).

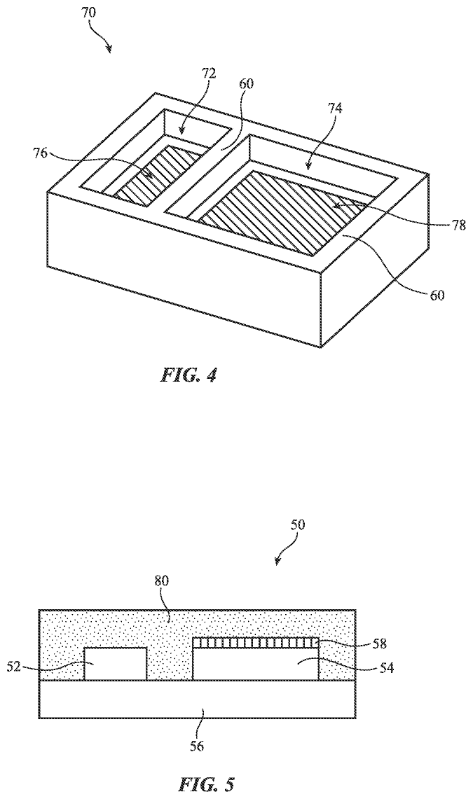

FIG. 4 shows a perspective view of sensor assembly cap 70. As shown in FIG. 4, cap 70 may be a structure having sidewalls 60 surrounding a first slot 72 and a second slot 74. The first slot 72 may be configured to receive a glass or other transparent layer (see, e.g., first glass layer 62 of FIG. 3 disposed directly above emitter component 52), whereas the second slot 74 may be configured to receive another glass or transparent layer (see, e.g., second glass layer 62 disposed directly above sensor die 54). Glass or transparent layer 62 may serve as a protective cover layer for housing the components 52 and 54 within sensor assembly 50. Sidewalls 60 may further form a first recess (see shaded region 76) directly below slot 72 and a second recess (see shaded region 78) directly below slot 74. When assembled, the emitting component 52 can be disposed within recess 76, and the sensor die 54 can be disposed within recess 78. One of the sidewalls 60 interposed between emitting component 52 and sensor die 54 may serve as a midwall that can help reduce an amount of optical crosstalk between emitter 52 and sensor die 54. Cap 70 can be formed using plastic, polymer, or other opaque rigid material.

The example shown in FIGS. 3 and 4 in which the optical sensor assembly 50 has a cap 70 with a midwall for reduced crosstalk is illustrative. In other suitable embodiments, cap 70 can be omitted and optical sensor assembly 50 may alternatively be covered with overmold material. FIG. 5 is a top view of optical hinge angle sensor assembly 50 with overmold. As shown in FIG. 5, overmold 80 may be formed over emitter component 52 and sensor die 54. Overmold 80 can be soft silicone, rigid silicone, hard epoxy, resin, molding wax, acrylic, plastic, polymer, or other transparent material that can be deposited on substrate 56 using an overmolding or injection molding process. Sensor assembly 50 with overmold may be more cost effective than the embodiment of FIG. 3 where sensor assembly 50 includes a cap.

Referring back to FIG. 3, emitter 52 may be a light-emitting diode (LED), a laser diode, or other types of light emitting component. Emitter 52 can be configured to output unpolarized light such as near infrared (NIR) light, infrared (IR) light, ultraviolet (UV) light, X-rays, gamma rays, microwaves, radio waves, light with any non-visible wavelength(s), or visible light. During angle sensing operations, emitter 52 may be configured to emit unpolarized light 64 towards encoder disc 43. The unpolarized light 64 may traverse linear polarizer layer 42 and emerge as polarized light. The polarized light exiting layer 42 may be reflected and scattered back in the opposing direction by reflective diffuser layer 44. The reflected light may traverse linear polarizer layer 42 and emerge again as polarized light 66. The exact polarization orientation (direction) of light 66 exiting the angle encoder disc 43 may depend on the amount by which hinge 30 has been rotated about axis 28, which changes rotational orientation of the wire grids within linear polarizer layer 42 as described herein in connection with FIGS. 9A and 9B. In other words, the rotational angle of the hinge structures can be encoded by the polarization direction/orientation of the light 66 reflecting back towards optical sensor assembly 50.

In the example of FIG. 3, the rotational axis 28 of the hinge is aligned or intersects with sensor die 54. This is merely illustrative. As another example, the rotational axis 28 of the hinge can be aligned with or intersect emitter 52. As another example, the rotational axis 28 of the hinge can be aligned with or intersect a region between sensor die 54 and emitter 52. These examples in which the hinge axis 28 is aligned with optical sensor assembly 50 (e.g., where the distal end of the hinge assembly is directly facing optical sensor assembly 50) is sometimes referred to as providing an “on-axis” optical sensing. Compared to conventional magnetic angle sensors, optical sensor assembly 50 configured in this way may offer a small enough form factor to be placed on-axis within device 10.

In order to detect the polarization orientation of light 66 reflecting back from the encoder disc 43 at the hinge, a polarizing filter layer such as polarizing filter layer 58 may be disposed on top of sensor die 54. Sensor die 54 may generally include one or more photodetectors such as photodiodes or other photosensitive elements. For example, sensor die 54 may include a one dimensional (1D) or two dimensional (2D) array of photodiodes. In accordance with some embodiments, polarizing filter layer 58 may be implemented as a pixelated polarizing filter, sometimes referred to as a pixelated polarizer. Pixelated polarizer 58 may refer to or be defined herein as a polarizing filter divided into multiple sub-filter portions with different polarization orientations (direction). Each portion of polarizer 58 with a different polarization orientation is sometimes referred to as a polarizer pixel.

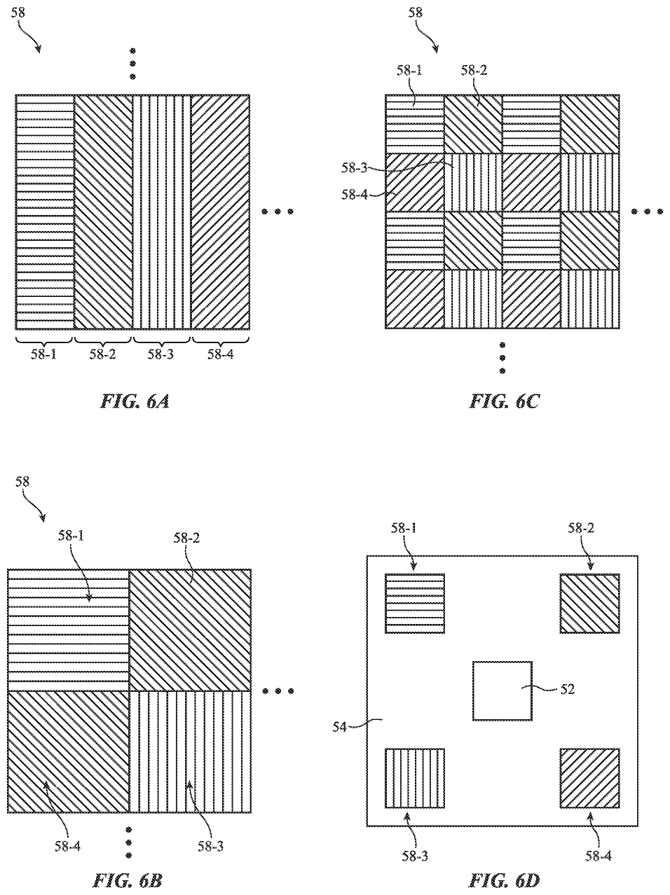

FIGS. 6A-6D are top views of various pixelated polarizers 58 having polarizer pixels offset by 45 degree increments. FIG. 6A shows a pixelated polarizer 58 with a linear (one dimensional) array of 4×1 polarizer pixels. As shown in FIG. 6A, pixelated polarizer 58 may include a first polarizer pixel 58-1 having wires arranged in a first polarization orientation, a second polarizer pixel 58-2 having wires arranged in a second polarization orientation that is offset (rotated clockwise) by 45° with respect to the first polarization orientation, a third polarizer pixel 58-3 having wires arranged in a third polarization orientation that is offset (rotated clockwise) by 45° with respect to the second polarization orientation and by 90° with respect to the first polarization orientation, and a fourth polarizer pixel 58-4 having wires arranged in a fourth polarization orientation that is offset (rotated clockwise) by 45° with respect to the third polarization orientation and by 135° with respect to the first polarization orientation. The term “wire” used here need not necessarily refer to a metal line but may generally refer to any individual polarizing member or structure. Each of these polarizer pixels may be formed directly above and cover (overlap) a respective photodetector in sensor die 54 below (e.g., sensor die 54 may include a 4×1 linear array of photodiodes corresponding to and aligned with the polarizer pixels shown in FIG. 6A). The pixel pattern of FIG. 6A can optionally be repeated across the plane of the sensor surface.

FIG. 6B shows another embodiment of a pixelated polarizer 58 with a 2D array of 2×2 polarizer pixels. As shown in FIG. 6B, pixelated polarizer 58 may include a first polarizer pixel 58-1 having wires arranged in a first polarization orientation, a second polarizer pixel 58-2 having wires arranged in a second polarization orientation that is offset (rotated clockwise) by 45° with respect to the first polarization orientation, a third polarizer pixel 58-3 having wires arranged in a third polarization orientation that is offset (rotated clockwise) by 45° with respect to the second polarization orientation and by 90° with respect to the first polarization orientation, and a fourth polarizer pixel 58-4 having wires arranged in a fourth polarization orientation that is offset (rotated counterclockwise) by 45° with respect to the third polarization orientation and that is parallel to the second polarization orientation. First polarizer pixel 58-1 may be located in the upper left quadrant in the top view of FIG. 6B; second polarizer pixel 58-2 may be located in the upper right quadrant; third polarizer pixel 58-3 may be located in the lower right quadrant; and fourth polarizer pixel 58-4 may be located in the lower left quadrant. Each of these polarizer pixels may be formed directly above and cover (overlap) a respective photodetector in sensor die 54 below (e.g., sensor die 54 may include a 2×2 array of photodiodes corresponding to and aligned with the polarizer pixels shown in FIG. 6B). The pixel pattern of FIG. 6B can optionally be repeated across the plane of the sensor surface.

FIG. 6C shows another embodiment of a pixelated polarizer 58 with a 2D array of 4×4 polarizer pixels. As shown in FIG. 6C, pixelated polarizer 58 may include four unit cells (pixel groups), each having a first polarizer pixel 58-1 having wires arranged in a first polarization orientation, a second polarizer pixel 58-2 having wires arranged in a second polarization orientation that is offset (rotated clockwise) by 45° with respect to the first polarization orientation, a third polarizer pixel 58-3 having wires arranged in a third polarization orientation that is offset (rotated clockwise) by 45° with respect to the second polarization orientation and by 90° with respect to the first polarization orientation, and a fourth polarizer pixel 58-4 having wires arranged in a fourth polarization orientation that is offset (rotated clockwise) by 45° with respect to the third polarization orientation and by 135° with respect to the first polarization orientation. This 2×2 unit cell may be repeated four times to make up the 4×4 array of polarizer pixels. Each of these polarizer pixels may be formed directly above and cover (overlap) a respective photodetector in sensor die 54 below (e.g., sensor die 54 may include a 4×4 array of photodiodes corresponding to and aligned with the polarizer pixels shown in FIG. 6C). The pixel pattern of FIG. 6C can optionally be repeated across the plane of the sensor surface.

The examples of FIGS. 6A, 6B, and 6C in which the polarizer pixels with different orientations are contiguous are illustrative. FIG. 6D shows yet another embodiment in which the various polarizer pixels are non-contiguous. As shown in FIG. 6D, a first polarizer pixel 58-1 having wires arranged in a first polarization orientation may be disposed at a first corner of substrate 56; a second polarizer pixel 58-2 having wires arranged in a second polarization orientation that is offset (rotated clockwise) by 45° with respect to the first polarization orientation may be disposed at a second corner of substrate 56; a third polarizer pixel 58-3 having wires arranged in a third polarization orientation that is offset (rotated clockwise) by 45° with respect to the second polarization orientation and by 90° with respect to the first polarization orientation may be disposed at a third corner of substrate 56; and a fourth polarizer pixel 58-4 having wires arranged in a fourth polarization orientation that is offset (rotated counterclockwise) by 45° with respect to the third polarization orientation and by 135° relative to the first polarization orientation may be disposed at a fourth corner of substrate 56. These spatially separated pixels 58-1, 58-2, 58-3, and 58-4 can be referred to collectively as a pixelated polarizer. Each of these polarizer pixels may be formed directly above and cover (overlap) a respective photodetector in sensor die 54 below (e.g., sensor die 54 may include at least four separate photodiodes formed at the corners of die 54 and aligned with the polarizer pixels shown in FIG. 6C). Emitter 52 may be stacked in the center of die 54. The stacked emitter component 52 may optionally be aligned with the rotational axis of the hinge.

The example of FIGS. 6A-6D in which pixelated polarizer 58 has a square shape is merely illustrative. If desired, pixelated polarizer 58 can have a rectangular shape, a circular shape, an oval shape, a triangular shape, a pentagonal shape, a hexagonal shape, an octagonal shape, other regular shape, or an irregular shape.

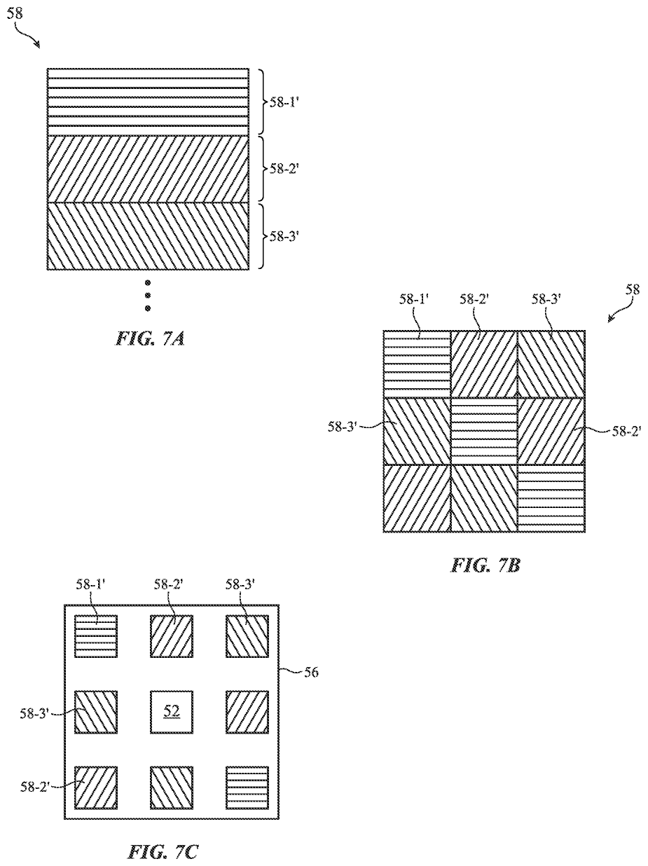

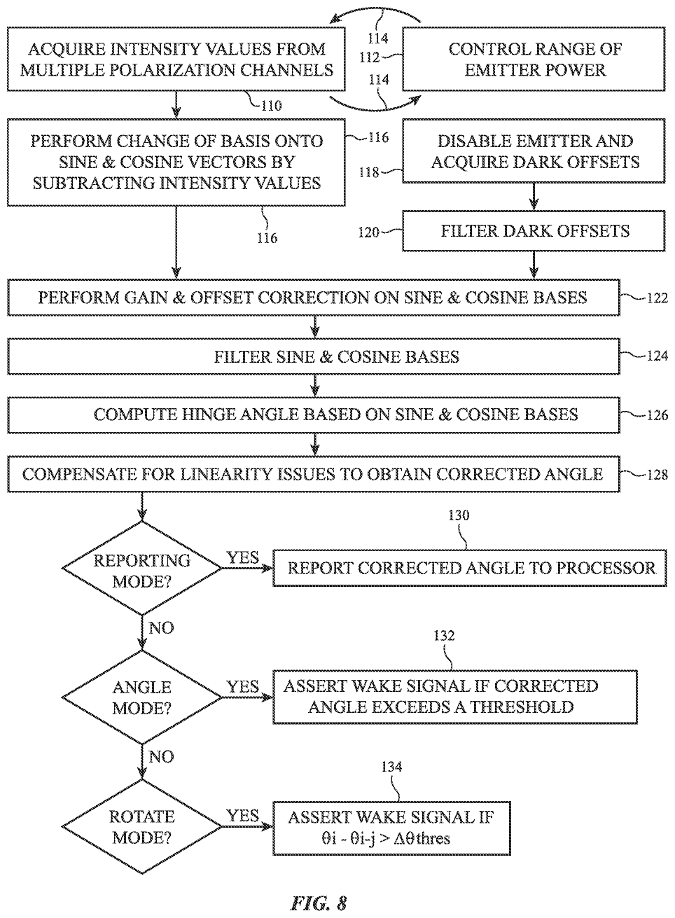

The embodiments of FIGS. 6A, 6C, and 6D in which pixelated polarizer 58 includes polarizer pixels of four different polarization orientations is exemplary. FIG. 7A shows a pixelated polarizer 58 with a linear (one dimensional) array of 3×1 polarizer pixels that are offset by 60 degree increments. As shown in FIG. 7A, pixelated polarizer 58 may include a first polarizer pixel 58-1′ having wires arranged in a first polarization orientation, a second polarizer pixel 58-2′ having wires arranged in a second polarization orientation that is offset (rotated counterclockwise) by 60° with respect to the first polarization orientation, and a third polarizer pixel 58-3′ having wires arranged in a third polarization orientation that is offset (rotated counterclockwise) by 60° with respect to the second polarization orientation and by 120° with respect to the first polarization orientation. Each of these polarizer pixels may be formed directly above and cover (overlap) a respective photodetector in sensor die 54 below (e.g., sensor die 54 may include a 3×1 linear array of photodiodes corresponding to and aligned with the polarizer pixels shown in FIG. 7A). The pixel pattern of FIG. 7A can optionally be repeated across the plane of the sensor surface.

FIG. 7B shows another embodiment of a pixelated polarizer 58 with a 2D array of 3×3 polarizer pixels. As shown in FIG. 7B, pixelated polarizer 58 may be divided into nine nonants. The term “nonant” may refer to or be defined herein as a portion of a whole area divided into nine sections. Pixelated polarizer 58 may include a first polarizer pixel having wires arranged in a first polarization orientation disposed in the upper left nonant (see pixel 58-1′), a second polarizer pixel having wires arranged in a second polarization orientation that is offset (rotated counterclockwise) by 60° with respect to the first polarization orientation disposed in the upper middle nonant (see pixel 58-2′), a third polarizer pixel having wireless arranged in a third polarization orientation that is offset (rotated counterclockwise) by 60° with respect to the second polarization orientation disposed in the upper right nonant (see pixel 58-3′), and so on as shown in the pattern of FIG. 7B. Each of these polarizer pixels may be formed directly above and cover (overlap) a respective photodetector in sensor die 54 below (e.g., sensor die 54 may include a 3×3 array of photodiodes corresponding to and aligned with the polarizer pixels shown in FIG. 7B). The pixel pattern of FIG. 7B can optionally be repeated across the plane of the sensing surface.

The examples of FIGS. 7A and 7B in which the polarizer pixels with different orientations are contiguous are illustrative. FIG. 7C shows yet another embodiment in which the various polarizer pixels are non-contiguous. As shown in FIG. 7C, a first polarizer pixel 58-1′ having wires arranged in a first polarization orientation may be disposed at a first corner of substrate 56; a second polarizer pixel 58-3′ having wires arranged in a second polarization orientation that is offset (rotated counterclockwise) by 120° with respect to the first polarization orientation may be disposed at a second corner of substrate 56; a third polarizer pixel 58-2′ having wires arranged in a third polarization orientation that is offset (rotated counterclockwise) by 60° with respect to the first polarization orientation may be disposed directly between the first and third polarizer pixels; and so on in the pattern shown in the top of FIG. 7C. These spatially separated pixels incrementally offset by 60 degrees can be referred to collectively as a pixelated polarizer. Each of these polarizer pixels may be formed directly above and cover (overlap) a respective photodetector in sensor die 54 below (e.g., sensor die 54 may include at least eight separate photodiodes aligned with the polarizer pixels shown in FIG. 7C). Emitter 52 may be stacked in the center of sensor die 54. The stacked emitter component 52 may optionally be aligned with the rotational axis of the hinge.

The examples of FIGS. 6A-6D that include adjacent polarizing pixels rotated by 45° and the examples of FIGS. 7A-7C that include adjacent polarizing pixels rotated by 60° are merely illustrative and are not intended to limit the scope of the present embodiments. As another example, pixelated polarizer 58 may include a 1D or 2D array of pixels with five different polarization orientations (directions) successively offset or rotated by 36°. As another example, pixelated polarizer 58 may include a 1D or 2D array of pixels with six different polarization orientations successively offset or rotated by 30°. As another example, pixelated polarizer 58 may include a 1D or 2D array of pixels with seven different polarization orientations successively offset or rotated by 25.71° (i.e., 180° divided by seven). As another example, pixelated polarizer 58 may include a 1D or 2D array of pixels with eight different polarization orientations successively offset or rotated by 22.5°. As another example, pixelated polarizer 58 may include a 1D or 2D array of pixels with nine different polarization orientations successively offset or rotated by 20°. As another example, pixelated polarizer 58 may include a 1D or 2D array of pixels with ten different polarization orientations successively offset or rotated by 18°. As another example, pixelated polarizer 58 may include a 1D or 2D array of pixels with two different polarization orientations offset or rotated by 90°. As another example, polarizing filter layer 58 by be a linear polarizer with only one polarization orientation (direction).

Pixelated polarizing filter layer 58 can be formed in various ways. In one embodiment, layer 58 can be formed as a pixelated wire grid polarizer that is manufactured using a secondary fabrication process over the sensor die 54. For instance, one or more sensor die(s) 54 can first be manufactured using a first application-specific integrated circuit (ASIC) or complementary metal-oxide-semiconductor (CMOS) wafer process and then passed to a secondary wafer process. During the secondary wafer process, a passivation layer can be formed on top of sensor 54, a layer of metal such as aluminum can be deposited on the passivation layer, a layer of photoresist can be formed on the layer of metal, nanoimprint lithography or other photolithography techniques can be used to pattern the layer of photoresist, and etching operations can then be used to pattern the metal layer to obtain the desired wire grid polarization pattern (e.g., to produce a pixelated polarizer with two or more unique polarization orientations/directions).

In another embodiment, layer 58 can be formed as a pixelated wire grid polarizer that is manufactured as a separate discrete component. For instance, one or more sensor die(s) 54 can first be manufactured using an ASIC or CMOS wafer process. In a separate process, a layer of metal such as aluminum can be deposited on a passive substrate layer such as a glass layer, a layer of photoresist can be formed on the layer of metal, nanoimprint lithography or other photolithography techniques can be used to pattern the layer of photoresist, and etching operations can then be used to pattern the metal layer to obtain the desired wire grid polarization pattern (e.g., to produce a pixelated polarizer with two or more unique polarization orientations/directions). The resulting patterned structure can be diced into individual filter components, which can then be picked and placed on and adhered to respective sensor dies 54.

In another embodiment, layer 58 can be formed using polarized dichroic dyes. For instance, one or more sensor die(s) 54 can first be manufactured using an ASIC or CMOS wafer process. Dyes such as azo dyes, azomethine-azo dyes, anthraquinone dyes, phtalocyanine dyes, a combination of these materials, or other dichroic dyes can be deposited on top of sensor 54 using a spin-on process (as an example). Separate regions of the deposited dye layer can then be cured using linearly polarized light such as linearly polarized ultraviolet light to photo align the dichroic dyes to obtain the desired wire grid polarization pattern (e.g., to produce a pixelated polarizer with two or more unique polarization orientations/directions).

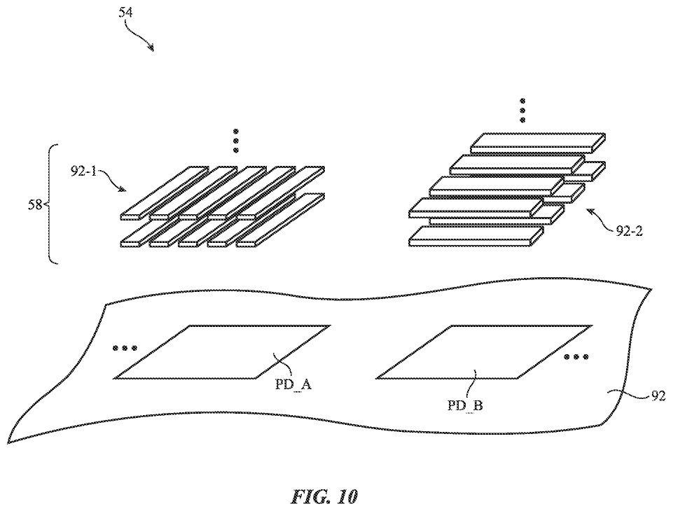

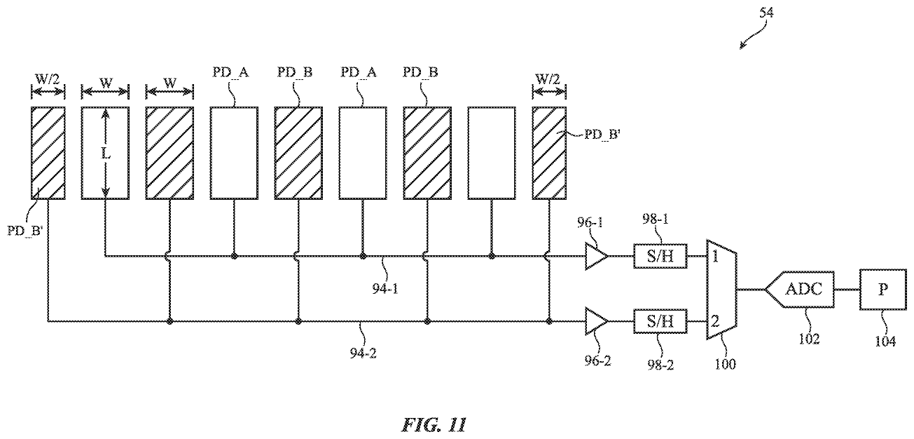

FIG. 10 shows another embodiment in which layer 58 can be formed as part of the metallization layers of sensor die 54. In other words, polarization layer 58 may be formed using the native ASIC or CMOS wafer process that is used to fabricate sensor die 54. Fabricating polarization layer 58 as part of the native semiconductor process can be beneficial and technically advantageous by providing a very cost effective way of implementing a pixelated polarizer for the optical angle sensor. As shown in FIG. 10, a plurality of photosensitive elements such as photodiodes PD_A and PD_B may be formed in a semiconductor substrate 92. Interconnect routing layers may be formed over substrate 92. The interconnect routing layers may include alternating metal routing layers and via (contact) layers, where metal routing lines in the metal routing layers and metal vias in the via layers are insulated by dielectric material. The interconnect routing layers are therefore sometimes referred to as a dielectric stack formed over substrate 92.

Wire grid polarizer 58 may be formed using metal routing lines in the interconnect routing layers. In FIG. 10, a first group of metal lines 92-1 routed in a first direction (orientation) are formed over first photodiode PD_A, whereas a second group of metal lines 92-2 routed in a second direction (orientation) orthogonal to the first direction are formed over second photodiode PD_B. The first group of metal lines 92-1 may include at least two layers of metal lines all routed parallel to the first orientation. The second group of metal lines 92-2 may include at least two layers of metal lines all routed parallel to the second orientation. If desired, groups 92-1 and 92-2 can each include three or more layers of parallel polarizing metal wires. In general, more layers of metal lines can help improve the quality of polarization. Although two orthogonal wires are shown in FIG. 10, wire grid polarizer 58 with metal grids formed in the dielectric stack can generally include wire grids with metal lines routed in three or more unique rotational orientations, four or more unique rotational orientations, only one orientation (e.g., to form a linear polarizer), or any number of different rotational orientations incrementally offset by 18°, 19°, 20°, 25°, 30°, 33°, 45° (as shown in FIGS. 6A-6D), 60° (as shown in FIGS. 7A-7C), 90°, or other suitable angle(s) to implement a pixelated polarizer.

FIG. 8 is a flow chart of illustrative steps for operating an optical hinge angle sensor of the type described in connection with FIGS. 1-7, 9, and 10. During the operations of block 110, emitter component 52 can emit unpolarized light, which is then reflected back by angle encoder disc 43 as polarized light 66. The exact polarization orientation of the reflected light 66 may be a function of the amount by which the hinge is rotated (see hinge angle θ in FIG. 2). The reflected light 66 may be filtered by polarizer layer 58 and sensed by an array of photodetectors in sensor die 54. For example, an array of photodiodes in sensor die 54 can be used to acquire intensity values from multiple polarization channels. The term polarization “channel” may refer to an output associated with a unique polarization direction of the pixelated polarizer layer 58. For example, the embodiments of FIGS. 6A-6D may include at least four groups of photodiode(s) that produce four corresponding intensity values via four respective polarization channels, whereas the embodiments of FIGS. 7A-7C may include at least three groups of photodiode(s) that produce three corresponding intensity values via three respective polarization channels. The intensity values may be measured in terms of the amount of photocurrent or voltage generated by light 66. The various intensity values output from the multiple channels can optionally be amplified, multiplexed, and converted to digital output values.

During the operations of block 112, control circuitry can be used to control the power of emitter component 52. The operations of block 112 can optionally operate continuously or periodically to ensure that the emitter intensity output range is within a certain dynamic range, as shown by feedback loop 114.

During the operations of block 116, processing circuitry such as digital processing (compute) circuitry on sensor 54 or other processing circuitry in device 10 (e.g., one or more processors in control circuitry 20 of FIG. 1) can be used to change the basis of the intensity values acquired from the operations of block 110. The processing circuitry can perform the change of basis by projecting, converting, or transforming the intensity values onto sine and cosine bases (vectors). For example, consider the embodiments described in connection with FIGS. 6A-6D in which sensor die 54 has an overlapping pixelated polarizer 58 with at least four differently oriented pixels 58-1, 58-2, 58-3, and 58-4. A change of bases into sine and cosine vectors can be performed by computing the difference between pairs of intensity values in accordance with the following equations:

$${S}_{1} = {P}_{0} - {P}_{90} = \frac{1}{4} cos ( 2 θ ) \qquad ( 1 )$$

$${S}_{2} = {P}_{45} - {P}_{135} = \frac{1}{4} sin ( 2 θ ) \qquad ( 2 )$$

where S₁ corresponds to a cosine basis obtained by computing a difference value between P₀ and P₉₀ and where S₂ corresponds to a sine basis obtained by computing a difference value between P₄₅ and P₁₃₅. P₀ may represent an intensity value acquired using polarizing pixel 58-1. P₉₀ may represent an intensity value acquired using polarizing pixel 58-3. P₄₅ may represent an intensity value acquired using polarizing pixel 58-2. P₁₃₅ may represent an intensity value acquired using polarizing pixel 58-4. Theta θ is the rotational angle of the hinge.

During the operations of block 118, emitter 52 may be disabled to acquire dark offset values. Dark offsets may include contribution from dark current, leakage, or other non-optical noise sources. The dark offset values can vary across the different channels. The dark offset values can optionally be filtered (e.g., using a single pole infinite impulse response low pass filter or other low pass filter) during the operations of block 120. The operations of blocks 118 and 120 can be performed infrequently, once per acquisition frame, or every n frames (where n can be 10, 100, 1000, 10-1000, more than 1000, or any other integer value).

During the operations of block 122, the processing circuitry can be used to perform gain and offset correction to the sine and cosine bases (vectors). For instance, the sine and cosine vectors can be corrected using the following equations:

$${S}_{1}^{′} = A * {S}_{1} + {B}_{D} + {B}_{L} \qquad ( 3 )$$

$${S}_{2}^{′} = C * {S}_{2} + {D}_{D} + {D}_{L} \qquad ( 4 )$$

where S₁ is the sine vector computed from block 116, A is the gain factor that is applied to the sine vector, B_{D} is the dark offset generated at the output of block 120 that is applied to the sine vector, B_{L} is the light offset to be applied to the sine vector, and S₁′ is the corrected sine vector. Similarly, S₂ is the cosine vector computed from block 116, C is the gain factor that is applied to the cosine vector, D_{D} is the dark offset generated at the output of block 120 that is applied to the cosine vector, D_{L} is the light offset to be applied to the cosine vector, and S₂′ is the corrected cosine vector. Unlike the dark offset values, the light offset values B_{L} and D_{L} represent contribution from optical crosstalk, ambient light, or other optical noise sources. The gain values A and C and the light offset values B_{L} and D_{L} can be measured using calibration operations at the time of production (e.g., at the factory). During the operations of block 124, the corrected sine vector S₁′ and the corrected cosine vector S₂′ can optionally be filtered (e.g., using a single pole infinite impulse response low pass filter or other low pass filter).

During the operations of block 126, the rotational angle θ of the hinge (sometimes referred to as the hinge angle) can be computed as follows:

$$θ = \frac{1}{2} a tan 2 ( {S}_{2}^{′} , {S}_{1}^{′} ) \qquad ( 5 )$$

where “a tan 2” is the two-argument arctangent function. In other words, the sine and cosine vectors are transformed to a hinge angle during block 126. If desired, a quantized arctangent function or other geometric math function can be used to compute hinge angle θ. During the operations of block 128, a polynomial or lookup table based correction can optionally be applied to the computed hinge angle to fix any potential linearity issues. For example, a Lissajous curve or other polynomial or parametric curve fitting technique can be employed to further mitigate any non-linearities associated with hinge angle θ.

The computation or reporting of the hinge angle using the operations of blocks 110-128 described above may at least partially depend on the mode of operation of device 10. For example, device 10 may be operable in a reporting mode, an angle mode, and/or a rotate mode. When operating in the reporting mode as shown in the operations of block 130, the hinge angle θ can be computed continuously (e.g., once every 10 ms, once every 20 ms, once every 10-50 ms, once every 50-100 ms, etc.). Alternatively, a group of 100 hinge angles θ can be computed, spaced out by 10 millisecond intervals and the reporting subsequently halted.

One or more hinge angles computed in this way can be reported out to one or more processors or other control circuitry on device 10. The computed hinge angle can be used by the control circuitry on device 10 to determine whether the device is in a sleep mode or a wake mode. As another example, the computed hinge angle can be used to control a cooling fan within device 10. As another example, the computed hinge angle can be used to trigger an animation on display 14 as the hinge is being rotated. As another example, the computed hinge angle can be used to configure display 14 in a split-screen mode when the computed angle is within a certain predetermined range.

When operating in the angle mode as shown in the operations of block 132, the control circuitry on device 10 may assert a wake or interrupt signal if the corrected hinge angle θ output from block 128 exceeds a certain threshold. When the hinge angle is less than the threshold, device 10 may be operated in a low power or sleep mode. The control circuitry can raise a wake signal if the corrected hinge angle is greater than 7° when rotated from a closed (folded) position. This is merely illustrative. If desired, the threshold wake angle can be set equal to 3° or more, 4° or more, 5° or more, 6° or more, 5-10°, 10-15°, 15-20°, 20-25°, 25-30°, or greater than 30°.

When operating in the rotate mode as shown in the operations of block 134, the control circuitry on device 10 may assert the wake or interrupt signal if the hinge angle is rotated from its prior position by more than a delta threshold. Device 10 may be operated in a low power or sleep mode when idled for some period of time. The control circuitry can raise an interrupt signal if the hinge angle rotates from its prior previous position by more than 7°. As an example, this can occur when the hinge angle changes from 60° to 68°. As another example, this can occur when the hinge angle changes from 92° to 100°. This example in which the delta threshold level is 7° is merely illustrative. In other embodiments, the delta threshold level can be set equal to 1°, 2°, 3°, 4°, 5°, 6°, 7°, 8°, 9°, 10°, less than 10°, less than 9°, less than 8°, between 5 and 10 degrees, or other threshold amount.

At least some of the methods and operations described above in connection with FIG. 8 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., control circuitry 20 and/or communications circuitry 22 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., control circuitry 20 and communications circuitry 22 of FIG. 1, etc.). The processing circuitry may include microprocessors, application processors, digital signal processors, central processing units (CPUs), application-specific integrated circuits with processing circuitry, or other processing circuitry.

The embodiments of FIGS. 6A-6D employing a pixelated polarizer with four different orientations are exemplary. FIG. 11 illustrates another embodiment that uses a pixelated polarizer with only two different (orthogonal) orientations. As shown in FIG. 11, sensor die 54 may include a linear array of alternating photodiodes PD_A and PD_B (e.g., photodiodes PD_A may be interleaved or interlaced with photodiodes PD_B). Photodiodes PD_A may represent a first group of photodetectors having an overlapping wire grid polarizer with wires routed in a first orientation (see, e.g., interconnect wires 92-1 of FIG. 10), whereas photodiodes PD_B may represent a second group of photodetectors having an overlapping wire grid polarizer with wires routed in a second orientation orthogonal to the first orientation (see, e.g., interconnect wires 92-2 of FIG. 10). Photodiodes PD_A and PD_B may each have the same area having width W and length L. The array of interlaced photodiodes may be flanked by photodiodes PD_B′, which represent photodiodes having an overlapping wire grid polarizer with wires routed in the second orientation and having half the area of photodiodes PD_A or PD_B. For instance, photodiode PD_B′ has an area with width W/2 and length L.

Photodiodes PD_A may all be coupled to a first readout channel (path) 94-1. Signals generated on the first readout channel 94-1 can optionally be buffered or amplified using driver circuit 96-1 and then received at sample-and-hold circuit 98-1. Photodiodes PD_B may all be coupled to a second readout channel (path) 94-2. Signals generated on the second readout channel 94-2 can optionally be buffered or amplified using driver circuit 96-2 and then received at sample-and-hold circuit 98-2. Sample-and-hold circuits 98-1 and 98-2 can be coupled to one or more processing circuits such as an analog-to-digital converter (ADC) via a switching circuit 100. Switching circuit 100 may be a multiplexer. All of the circuitry shown in FIG. 11 can be formed on sensor die 54. Configured in this way, the output of photodiodes PD_A and PD_B can be sampled simultaneously and in synchronization with the emitter component. The ADC conversion at block 102 and subsequent processing operations to compute hinge angle θ can optionally occur when the emitter component is turned off to save power.

The output of photodiodes PD_A and PD_B can be expressed as follows:

$$PD\_A \_out = k * \vert sin ( θ ) \vert + L\_leak \qquad ( 6 )$$

$$PD\_B \_out = k * \vert cos ( θ ) \vert + L\_leak \qquad ( 7 )$$

where L_leak represents an amount of light leakage, crosstalk, ambient light, or other optical noise sources that can contribute to the outputs of either photodiodes PD_A or PD_B. Alternating or spatially modulating the layout of photodiodes PD_A and PD_B (and also PD_B′) in the way shown in FIG. 11 can help ensure that L_leak between the two channels is approximately equal. In other words, spatially interlacing the multiple photodiode segments with orthogonal polarizer grids can help mitigate light leakage nonuniformity. The output of photodiodes PD_A can therefore sometimes be referred to as the sine basis, whereas the output of photodiodes PD_B can sometimes be referred to as the cosine basis. Once the sine and cosine bases have been converted to digital signals by converter 102, additional digital signal processing circuits 104 can be used to compute the hinge angle θ by computing the difference between PD_A_out and PD_B_out, which cancels out L_leak, and then employing an arctangent function using the sine and cosine bases as inputs.

The embodiment of FIG. 11 that uses a linear array of photodiodes PD_A and PD_B with orthogonal wire grid polarizer orientations is merely illustrative. If desired, a 2D array of photodiodes with orthogonal wire grids forming a checkboard pattern can be employed. If desired, overlapping wire grids with two or more different rotational orientations can be employed (e.g., the wires in the overlapping wire grids can be offset by 90°, 60°, 45°, 36°, 30°, 25.714°, 22.5°. 20°, 18°, or angular steps). If desired, the overlapping wire grids for the alternating photodiodes can be manufactured using a secondary fabrication process over the sensor die 54, can be manufactured as a separate discrete component, can be formed using dichroic polarization dyes, or can be formed as other pixelated polarization structures.

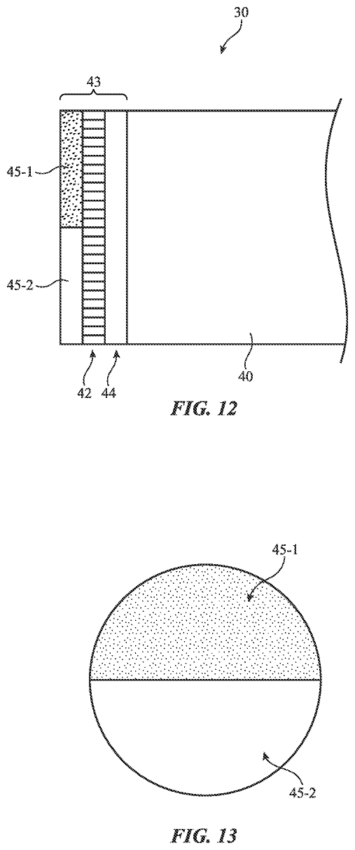

The embodiment of FIG. 3 in which angle encoder disc 43 has a single polarization filter layer 42 is merely illustrative. Such encoder disc where layer 42 is a linear polarizer across its entire surface as shown in the example of FIGS. 9A and 9B might be limited to a 180° angle sensing range since a 0° polarization is indistinguishable from a 180° polarization of the reflected light and similarly, a 90° polarization is indistinguishable from a 270° polarization of the reflected light. This angle sensing concept can be extended to cover a 360° range by adding an additional layer to the angle encoder disc 43 as shown in FIG. 12. In the embodiment of FIG. 12, angle encoder disc 43 may include an additional layer having a first portion 45-1 that is a bandpass filter and having a second portion 45-2 that is an all-pass filter.

Such encoder disc 43 can be illuminated using an emitter 52 capable of emitting light of two different wavelengths. For example, emitter 52 can include a first emitter component configured to emit light of a first wavelength and a second emitter component configured to emit light of a second wavelength. The two emitter components can be energized serially in a time-multiplexed fashion. If desired, the two emitter components can also be energized simultaneously in a parallel fashion.

The first bandpass filter portion 45-1 can be configured to pass through only light of the first wavelength while absorbing (filtering or blocking) light of the second wavelength. The second all-pass filter portion 45-2 can be configured to pass through light of both the first and second wavelengths. The first bandpass filter portion 45-1 can have a semicircle or halfmoon cross-sectional area (as shown by the side view in FIG. 13) and is sometimes referred to as a long-pass filter, short-pass filter, or edge-pass filter layer. The second bandpass filter portion 45-2 can also have a semicircle or halfmoon cross-sectional area (as shown by the side view of FIG. 13) and is sometimes referred to as a fully transparent or clear layer. Configured in this way, a ratio of the signal obtained from the emitted light of the first wavelength to the signal obtained from the emitted light of the second wavelength can inform whether the angle encoder disc is currently rotated in the 0-180° range or in the 180-360° range.

The embodiment of FIGS. 12 and 13 in which the hinge angle encoder disc 43 includes a filter layer divided into two half portions and is operated in conjunction with an emitter capable of emitting light of two different wavelengths is exemplary. In other embodiments, angle encoder disc 43 might include one or more filter layers divided into three pie or wedge shaped sections, four pie or wedge shaped sections, five pie or wedge shaped sections, 5-10 pie/wedge shaped sections, or more than 10 pie/wedge shaped sections. If desired, the emitter 52 can be configured to emit light at three different wavelengths, four different wavelengths, five different wavelengths, 5-10 different wavelengths, or more than 10 different wavelengths.

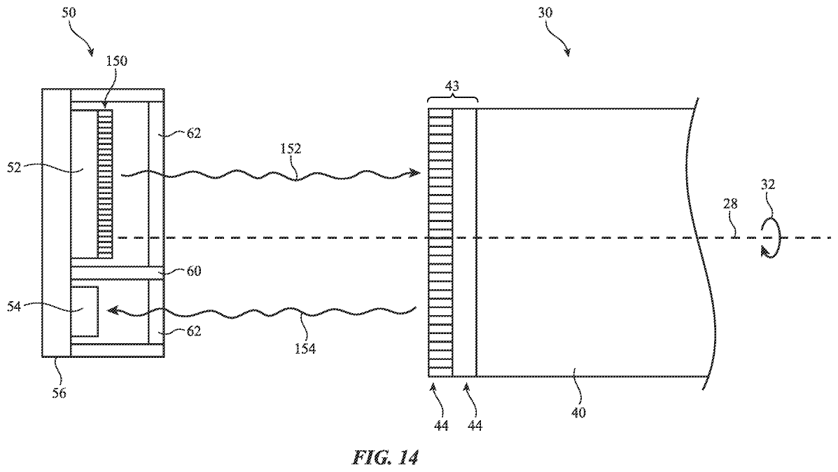

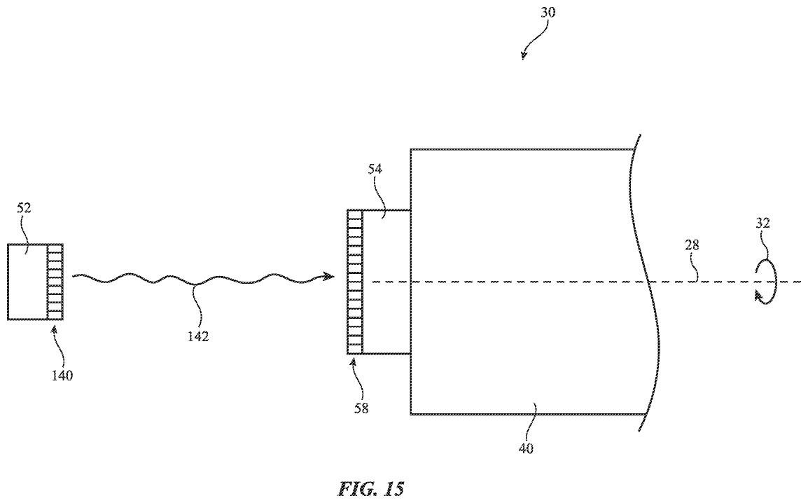

The embodiment of FIG. 3 in which pixelated polarizer 58 is formed over sensor die 54 within the optical sensor assembly is exemplary. FIG. 14 shows another embodiment in which the polarizing filter layer of the sensor assembly is instead formed over emitter 52. As shown in FIG. 14, a polarizing filter layer such as a linear polarizer 150 can be disposed over emitter 52. During angle sensing operations, emitter 52 may be configured to emit light that is immediately polarized by filter layer 150 to produce polarized light 152 that travels towards angle encoder disc 43. The polarized light 152 may traverse linear polarizer layer 42.

The amount of polarized light 152 that is transmitted through linear polarizer layer 42 may depend on the current hinge (rotational) angle θ. For example, when angle θ is zero, assuming the polarization orientation (axes) of layers 150 and 42 are aligned or parallel in this position, all of light 152 will be transmitted through layer 42. When angle θ is rotated to 90°, the polarization orientation of layers 150 and 42 will now be orthogonal, so none of light 152 will be transmitted through layer 42. When angle θ is rotated to some degree between 0° and 90° or between 90° and 180° (exclusive), a partial amount of light 152 will be transmitted through layer 42 and the amount of transmission will vary as a function of the rotational angle θ.

The light exiting layer 42 may be reflected and scattered back in the opposing direction by reflective diffuser layer 44. The reflected light may traverse linear polarizer layer 42 and emerge again as polarized light 154. The exact amount of light 154 exiting the angle encoder disc 43 may depend on the amount by which hinge 30 has been rotated about axis 28 in the direction of arrow 32. In other words, the rotational angle of the hinge structures can be encoded by the intensity of the light 154 reflecting back towards optical sensor assembly 50. Sensor die 54 may detect the amount of light 154 being reflected back from the angle encoder disc 43. In the example of FIG. 14, the rotational axis 28 of the hinge is shown as being aligned with emitter component 52. This is merely illustrative. As another example, the rotational axis 28 of the hinge can be aligned with sensor 54. As another example, the rotational axis 28 of the hinge can be aligned with a region between sensor die 54 and emitter 52.

The embodiment of FIG. 3 in which emitter 52 and sensor die 54 are formed on the same substrate facing an opposing angle encoder disc 43 is exemplary. FIG. 14 shows another embodiment in which emitter 52 and sensor 54 are directly facing one another. As shown in FIG. 14, a polarizing filter layer such as a linear polarizer 140 can be disposed over emitter 52. whereas sensor die 54 can be disposed on hinge structure 40 and facing emitter 52. In other words, sensor die 54 can be formed as part of the rotating hinge assembly. Configured in this way, emitter 52 and sensor die 54 can rotate relative to each other as the hinge swivels about axis 28. A pixelated polarizer 58 or a linear polarizer with only one polarization orientation can be formed on sensor die 54.

During angle sensing operations, emitter 52 may be configured to emit light that is immediately polarized by filter layer 140 to produce polarized light 142 that travels towards sensor die 54. The polarized light 142 may traverse pixelated polarizer layer 58. A method similar to the process of FIG. 8 can be used to compute the hinge angle θ. Here, the intensity of signals gathered by each photodiode under the pixelated polarizer 58 will be a function of the amount by which hinge 30 has been rotated about axis 28 in the direction of arrow 32. In yet another embodiment, the positions of emitter 52 and sensor 54 as shown in FIG. 15 can be swapped (e.g., emitter 52 with an overlapping linear polarizer 140 can be disposed on hinge structure 40 while sensor 54 with an overlapping pixelated polarizer 58 can be disposed opposing the emitter 52).

The foregoing is merely illustrative and various modifications can be made to the described embodiments. The foregoing embodiments may be implemented individually or in any combination.

What is claimed is:

1. An electronic device comprising:
housing comprising first and second housing portions that rotate relative to each other about a hinge;
a hinge angle encoding structure disposed on the hinge;
an emitter configured to emit light towards the hinge angle encoding structure;
a sensor die configured to receive the light reflecting back from the hinge angle encoding structure; and
a polarizing filter layer disposed on the sensor die.

2. The electronic device of claim 1, wherein the hinge angle encoding structure comprises:
an additional polarizing filter layer; and
a reflective diffuser layer interposed between the additional polarizing filter layer and the hinge.

3. The electronic device of claim 2, wherein the additional polarizing filter layer comprises a linear polarizer.

4. The electronic device of claim 2, wherein the additional polarizing filter layer comprises an absorptive polarizer.

5. The electronic device of claim 1, wherein the hinge angle encoding structure comprises a reflective polarizer.

6. The electronic device of claim 1, wherein the hinge angle encoding structure comprises:
an additional polarizing filter layer; and
a specular reflector layer interposed between the additional polarizing filter layer and the hinge.

7. The electronic device of claim 1, wherein the polarizing filter layer comprises a pixelated polarizer.

8. The electronic device of claim 1, wherein the polarizing filter layer comprises a pixelated polarizer with two or more different polarization orientations.

9. The electronic device of claim 1, wherein the polarizing filter layer comprises a pixelated polarizer with three or more different polarization orientations.

10. The electronic device of claim 1, wherein the polarizing filter layer comprises a pixelated polarizer implemented using multiple layers of metal wires formed in interconnect routing layers on a substrate of the sensor die.

11. The electronic device of claim 1, wherein the emitter is stacked on the sensor die.

12. The electronic device of claim 1, further comprising a sensor assembly cap that houses the sensor die and the emitter, the sensor assembly cap having a midwall separating the sensor die and the emitter.

13. The electronic device of claim 1, wherein:
the emitter is configured to emit light with first and second wavelengths; and
the hinge angle encoding structure comprises a layer having a first portion configured to pass light of the first wavelength while absorbing light of the second wavelength and having a second half portion configured to pass light of the first and second wavelengths.

14. A method of operating an optical hinge angle sensor in an electronic device having a plurality of housing portions that rotate with respect to each other about a hinge, the method comprising:
with an emitter, emitting light towards a hinge angle encoding structure on the hinge;
with a polarizing filter layer, polarizing the light reflecting back from the hinge angle encoding structure;
with a sensor die, sensing polarized light traversing the polarizing filter layer and outputting one or more intensity values; and
computing an angle at which the plurality of housing portions are rotated about the hinge based on the one or more intensity values.

15. The method of claim 14, wherein the hinge angle encoding structure comprises:
a linear polarizer layer; and
a reflective diffuser layer interposed between the linear polarizer layer and the hinge.

16. The method of claim 14, wherein the polarizing filter layer comprises a pixelated polarizer with three or more different polarization orientations.

17. The method of claim 14, wherein computing the angle comprises converting the intensity values to corresponding sine and cosine bases.

18. The method of claim 17, wherein computing the angle further comprises:
performing gain and offset correction on the sine and cosine bases;
filtering the sine and cosine bases; and
computing an arctangent function using the sine and cosine bases.

19. An electronic device comprising:
housing comprising first and second housing portions that rotate relative to each other about a hinge;
a hinge angle encoding structure disposed on the hinge; and
a sensor die facing the hinge angle encoding structure and comprising first and second photodetectors formed in a substrate,
interconnect routing layers formed on the substrate,
multiple layers of parallel polarizing metal lines in the interconnect routing layers routed in a first direction and overlapping the first photodetectors, and
multiple layers of parallel polarizing metal lines in the interconnect routing layers routed in a second direction orthogonal to the first direction and overlapping the second photodetectors.

20. The electronic device of claim 19, further comprising control circuitry configured to sample first signals output from the first photodetectors, to sample second signals output from the second photodetectors, to compute a difference of the first and second signals, and to compute a hinge angle at which the plurality of housing portions are rotated about the hinge based on the computed difference.
